(19) United States
(12) Patent Application Publication
(10) Pub. No.: US 2003/0230380 A1
(43) Pub. Date: Dec. 18, 2003

(54) Method and apparatus for applying pressure sensitive adhesive labels to a series of objects

(76) Inventors: Charles E. Greenhill, Lakewood, NJ (US); James Nogrady, Saddle Brook, NJ (US)

Correspondence Address: CLIFFORD G. FRAYNE, Suite 7A, 136 Drum Point Road, Brick, NJ, 08723, US

(21) Appl. No.: 10/172,965

(22) Filed: Jun. 17, 2002

(51) Int. Cl. B32B 31/00

(52) U.S. Cl. 156/249; 156/247; 156/569

(57) ABSTRACT

A method and apparatus for transferring a discrete pressure sensitive label from a continuous web of discrete pressure sensitive labels to a continuous series of discrete objects wherein the web and labels are brought into contact tangentially with a perforated rotating transfer machine mounted on a hub, the web and labels in contact with the perforated rotating transfer means for a portion of its arc of circumference, the label being subjected to a vacuum during rotation while simultaneously redirecting the web away from the perforated rotating transfer means, the label maintaining contact with the rotating transfer means until registration with a pressure port at which point the label is subjected to a pressurized gas flow and is blown from the rotating ring to the object to be labeled when that object is in registration and alignment with the pressure port.

### BACKGROUND OF THE INVENTION

1. Field of the Invention

The present invention relates to apparatus for applying labels to goods of any type, but having particular application to the application of labels to fruit and vegetables.

2. Description of the Prior Art

Most manufactured or harvested items on their journey during the manufacturing process or the post-harvest processing are subjected to travel at some point in time on a conveyer means, either for inspection, grading, or labeling, prior to their final packaging station. Applicant's invention has application to any situation where an item of manufacture requires the application of a label, but Applicant's apparatus has a special application to the application of labels on to fruit and vegetables.

The fruit and vegetables harvested from the field once cleaned and separated are normally fed onto a conveyer system in which the individual pieces of fruit and vegetables can be inspected, sorted, sized, graded and weighed. The elaborate conveyer system utilized for this sorting, sizing, grading or weighing of fruits and vegetables automatically transfers similarly graded fruits or vegetables to their own conveyer means, each piece of fruit or vegetable may be required to have a label affixed thereto. Since the effort has been undertaken to examine the fruit and vegetables and to sort it into the various grades, it is undesirable at this stage to damage the fruit or vegetable in the labeling process. Current state of the art machines will often times wound or mar the individual piece of fruit or vegetable in the labeling process.

The fruit and vegetables moving along a conveyer line do not always remain stationary, but sometimes rather, roll, spin and tumble as they are transported. Current state of the art label applicators will often times completely miss individual pieces of fruit and vegetables because of their motion. Still further, current state of the art label applicators cannot respond to random product sizes, shapes or weights, and this often times contributes to the wounding or marring of the surface of the fruit or vegetable or completely missing the labeling application.

As a result of these shortcomings in the prior art, the fruit and vegetable packers must employ additional people along the product line to watch for evidence of wounded fruit or vegetables or missed labels. They must also watch the labeling machines which are subject to jamming. They must also watch the conveyer means to insure that the labeling machines are applying the label to each and every piece of fruit and vegetable that requires labeling which is passing through the labeling station.

Applicant's label applicator eliminates the wounding, bruising, crushing, peeling of scuffing of the fruit or vegetable, in that the machine does not come in contact with the individual piece of fruit and vegetable, but rather transfers the label by a vacuum jet process. Further, Applicant's label applicator requires no adjustment for random product sizes, shapes or weights, and insures that a label is applied regardless of whether the produce is rolling, spinning, tumbling or the like.

### OBJECTS OF THE INVENTION

An object of the present invention is to provide for a novel apparatus for applying labels to items of manufacture or harvest.

Another object of the present invention is to provide for a novel apparatus for application of labels to items of manufacture or harvest which does not require the apparatus to come in contact with the item of manufacture or harvest.

A further object of the present invention is to provide for a novel apparatus for applying labels to fruits or vegetables which eliminates the bruising, crushing, peeling or scuffing of the fruit or vegetable.

A still further object of the present invention is to provide for a novel apparatus for the application of labels to fruit or vegetables which requires no adjustments for random product sizes, shapes or weights.

A still further object of the present invention is to provide for a novel apparatus for application of labels to fruits or vegetables which provides for application of the label regardless of whether the fruit or vegetable is rolling, spinning or tumbling.

A still further object of the present invention is to provide for a novel apparatus for the application of labels to fruits or vegetables which greatly reduces or eliminates the need for personnel to have to attend to the labeling process.

A still further object of the present invention is to provide for a novel apparatus for the application of labels to fruit or vegetables which increases productivity and decreases down time on the conveyer system.

A still further object of the present invention is to provide for an apparatus for the application of labels to fruits or vegetables which can run at higher speeds than that of the prior art.

A still further object of the present invention is to provide for a novel apparatus that does not require any label set up adjustment.

A still further object of the present invention is to provide for a novel apparatus that permits flexibility in label web tension, thus minimizing the possibility of the web breaking or tearing during the labeling process.

A still further object of the present invention is to provide for absolute minimal maintenance and service.

### SUMMARY OF THE INVENTION

A method and apparatus for transferring a discrete pressure sensitive label from a continuous web of discrete pressure sensitive labels to a continuous series of discrete objects wherein the web and labels are brought into contact tangentially with a perforated rotating transfer machine mounted on a hub, the web and labels in contact with the perforated rotating transfer means for a portion of its arc of circumference, the label being subjected to a vacuum during rotation while simultaneously redirecting the web away from the perforated rotating transfer means, the label maintaining contact with the rotating transfer means until registration with a pressure port at which point the label is subjected to a pressurized gas flow and is blown from the rotating ring to the object to be labeled when that object is in registration and alignment with the pressure port.

### BRIEF DESCRIPTION OF THE DRAWINGS

These and other objects of the present invention will become apparent particularly when in light of the following illustrations wherein:

FIG. 1 is a front view of the label applicator apparatus;

FIG. 2 is a close up front view of the label transfer means;

FIG. 3 is a side view of the surface of the label transfer means;

FIG. 4 is a perspective view of the rotary labeling ring associated with the label transfer means;

FIG. 5 is a partial underside view of the hub of label transfer means; and

FIG. 6 is a partial top view of the web and roller illustrating the pin and perforation guide and drive mechanism.

### DETAILED DESCRIPTION OF THE DRAWINGS

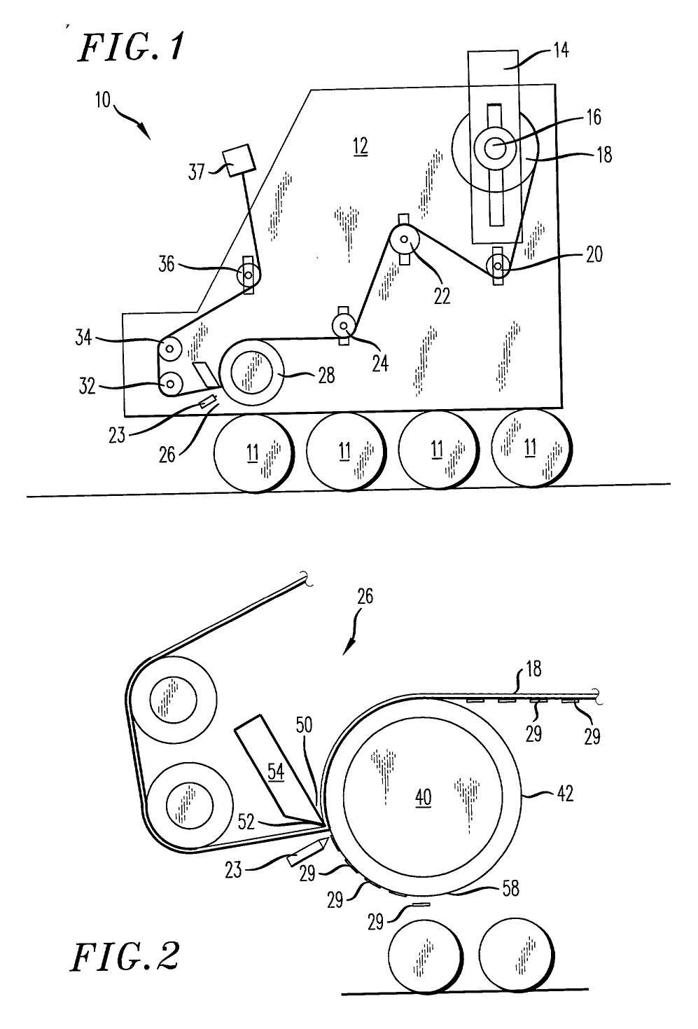

FIG. 1 is a perspective view of the label applicator apparatus 10 of the present invention illustrating its use with the application of labels to round items. In the illustration of FIG. 1, label applicator apparatus 10 is oriented in a vertical position, but it should be pointed out that the label applicator 10 can be oriented angularly if the labeling process requires it. In FIG. 1 there is a vertically oriented support member 12 on which is mounted a web cradle 14 having an adjustable axle 16 for the rotatable support of a continuous web 18 having pressure sensitive adhesive labels affixed thereon. A series of rollers 20, 22, and 24 transport guide the web and the associated labels into circumferential contact with that portion of the label applicator apparatus identified as the label transfer means 26.

At the label transfer means, the label on the web 18 is removed from the web 18 mechanically and temporarily affixed to a rotary or faceted ring 28 on the label transfer means 26 by means of a vacuum and may be assisted by a pressurized gas assist jet 23. The label remains on the rotating ring 28 until it comes in registration with a pressure port 30 (See FIG. 5) at which time the label is vac-jetted onto the item or product, in this case a round item. The web 18 once the label has been removed is guided by means of a variety of drive and guide rollers 32, 34, and 36 to a web collection means which could be a disposal container, shredder or the like 37. The web cradle 14 and the various drive and guide rollers are capable of being computer adjusted automatically in order to provide for the proper tension on the web during the labeling process. In addition, the web 18 may have perforations 39 along its longitudinal edges 19 cooperative with upstanding pins 33 on the various rollers to assist in guidance and transport (See FIG. 6).

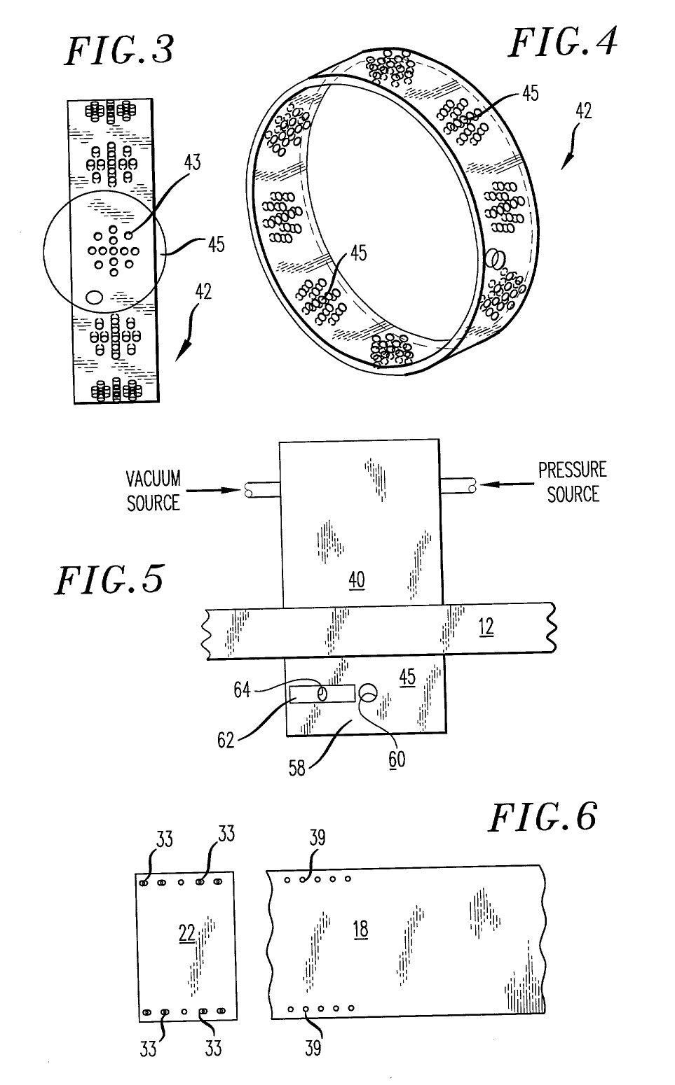

FIG. 2 is a close up view of the label transfer means 26 portion of the label applicator. The label transfer means 26 consists of a stationary hub 40 about which there rotates a perforated ring 42 which serves as the outer surface of the label transfer means and is best viewed with respect to FIGS. 3 and 4. The perforations 43 are arranged in a pattern 45 with each pattern sized to hold a label 29 under vacuum.

In the illustration, the web 18 first engages the label transfer means 26 at the uppermost tangent of the rotating ring 42 and the web travels in a counter-clockwise direction. It should be noted the web enters the label transfer means 26 with the label 29 face facing downwardly and the adhesive portion of the label juxtaposed the web.

In the illustration, the web travels counter-clockwise on ring 42 to position 50 where the web 18 is subjected to an approximate 90 degree turn about peel edge 52 of peel plate 54. At that point of 90 degree turning of the web, the ring member 42 having a plurality of perforations 43 about its surface and perforation patterns 45 is subjected to a vacuum means from a vacuum source, the conduit means for providing vacuum being positioned within the hub member 40. Ring 42 is subjected to a vacuum continuously from position 50 to the point at which the label is to be applied to the particular goods. Thus the label 29 is now rotating on ring 42 with adhesive surface facing outwardly. For purposes of discussion in the instant matter, we will assume that the label will be positioned on the goods when ring 42 and the associated label have rotated to the bottom dead center position 58. Therefore ring 42 would be under constant vacuum from position 50 until approximate bottom dead center position 58. At that point, the ring 42 would be subjected to a positive pressure through the perforations 43 in the ring 42 and to the label side of the label 29 when the label and perforation are in registration with a pressure port 60, thus blowing or vac-jetting the label off of the ring 42 and onto the goods 11, adhesive side first.

It should be noted that dependent upon the pressure required, it is possible to fix a label to a goods 11 with the apparatus and method of the present invention when the gap between the surface of the goods 11 and the ring 42 could be several inches.

Ring 42 would continue to rotate about hub 40 after passing bottom dead center, but would not be subjected to any vacuum during this portion of the rotation. When the ring rotated back to position 50, where it then would be subjected to a vacuum means from within hub 40. The fact that the labels are affixed to the web, adhesive side down, and the labels are fed into the label transport means 26 such that the label is in contact with the perforations 43 on ring 42 and the adhesive layer faces outwardly greatly reduces machine down time from the build up of adhesive on the moving parts of the labeling assembly.

FIG. 5 is a partial underside view of the hub 40 of the present invention with the rotating ring 42 removed. The ring would rotate about hub portion 45. It can be seen that for a portion of the arc of hub member 40 there is a recess slot 62 in communication with a conduit 64 which is in communication with a vacuum source or means (not shown). In operation this slot 62 extends from point 50 on ring 42 proximate the peel plate 54 and peel edge 52 to a point on the circumference of the hub immediately adjacent the pressure port 60 which for purposes of this illustration is located at the bottom dead center position 58. The pressure port 60 is in communication with a source of pressurized gas to vac-jet the label from ring 42 onto the goods to be labeled. When the label applicator apparatus 10 is operating, there is a constant vacuum drawn to slot 62. The pressurized gas directed to pressure port 60 may be continuous or may be intermittent and computer timed to the speed of rotation of ring 42 and speed of the goods 11. Similarly, it will be recognized by those of ordinary skill in the art that the internal piping of hub 40 and valving of such piping in order to provide the vacuum and pressurized gas may vary without departing from the spirit and scope of the invention.

For the illustration just discussed, we have assumed that the label will be affixed to the goods at the bottom dead center position 58 of the rotation of ring 42. It will be recognized that depending upon certain peculiarities with respect to labeling projects, the expiration point for the label 42 from the ring could be at a point other than bottom dead center position 58. The prerequisite is that the label be picked up by the vacuum means in association with ring 42 and held from the pick up point to the expiration point under vacuum. Still further, the feed of the web to the label transfer means could be clockwise and could also be vertical feed from above or below depending upon the configuration of the objects or goods transport configuration. The vacuum slot and pressure port would be oriented accordingly for such configuration. Still further, all of the drive rollers would be driven by a motor which could be mounted on the reverse side of support 12.

While the present invention has been described with respect to the exemplary embodiments thereof, it will be recognized by those of ordinary skill in the art that many modifications or changes can be achieved without departing from the spirit and scope of the invention. Therefore it is manifestly intended that the invention be limited only by the scope of the claims and the equivalence thereof.

I claim:

1. A method of transferring discrete pressure sensitive adhesive labels from a web carrier to a series of continuous objects, the method comprising:
a. positioning a wound web having discrete presure sensitive adhesive labels affixed thereon on an axle for rotation;
b. threading said web carrier about a plurality of directional, tensioning and drive rollers establishing a path to a web collection means;
c. positioning a label transfer means in the path of said web, said label transfer means comprising a hub having a ring rotatably mounted on said hub for contact with said web, said ring having a plurality of discrete perforation patterns thereon, said hub having a recessed slot formed in its periphery in alignment with said ring for a portion of said hubs circumference, said slot having a label engaging end and a label release end, said slot in communication through said hub to a vacuum source, said hub having a pressure port formed on its circumference proximate said label release end of said slot, said pressure port in communication through said hub with a pressurized gas source;
d. positioning a peel plate adjacent said ring and said web proximate said upper end of said slot, said peel plate redirecting said web from said ring to a plurality of directional, tensioning and drive rollers and to said web collection means;
e. activating vacuum to said slot in said hub;
f. activating transport of said continuous series of objects past said pressure port of said hub;
g. activating said drive roller and unwinding said web and said pressure sensitive adhesive labels;
h. transferring said label from said web to said ring at said label engaging end of said slot by means of said vacuum and redirection of said web by said peel plate;
i. maintaining said label on said ring by said vacuum until registration with said pressure port;
j. activating said pressure port with said label in registration with said port and said port is in registration and alignment with said object to be labeled;
k. transferring said label to said object under the influence of said pressurized gas source;
l. repeating steps h through k for said discrete labels of said web.

2. The method in accordance with claim 1 wherein the labels on said web are transferred to said ring with the adhesive side facing outwardly.

3. The method in accordance with claim 1 wherein a pressurized gas assist jet is positioned proximate the said peel plate and said ring to assist in the transfer of said label from said web to said ring.

4. The method in accordance with claim 1 wherein said plurality of directional, tensioning and drive rollers and said ring on said label transfer means are formed with pins on their circumferential periphery proximate their ends and said web is formed with perforations on its longitudinal edges cooperative with said pins for the guidance and transport of said web.

5. A label applicator assembly for transferring discrete pressure sensitive labels from a web to a continuous series of objects said applicator assembly comprising:
a source of labels affixed to a wound continuous web;
a web collection means;
a plurality of directional, tensioning and drive rollers positioned between said source of said labels and said web collection means for tensioning, directing and driving said web;
a label transfer means for transfer of said label from said web to said transfer means and thence to said objects to be labeled, said label transfer means comprising a hub having a ring rotatably mounted thereon, said ring having a plurality of discrete perforation patterns, said hub having a recessed slot formed in its circumferential periphery in alignment with said ring for a portion of said hub circumference said slot in communication through said hub to a vacuum source, said slot having a label engaging end and a label release end, said hub having a pressure port formed in its circumference proximate to said label release end of said slot said pressure port in communication through said hub with a pressurized gas source, a peel plate adjacent said ring and having a peel edge positioned proximate said label engaging end of said slot, said peel plate redirecting said web from said ring to a plurality of directional, tensioning and drive rollers and to said web collection means, said label being transferred at said peel edge from said web to said ring under the influence of vacuum and maintained on said ring until registration with said pressure port when said label is jetted from said ring onto said object to be labeled.

6. The label applicator assembly in accordance with claim 5 wherein the labels on said web are transferred to said ring with the adhesive side facing outwardly.

7. The label applicator assembly in accordance with claim 5 wherein a pressurized gas assist jet is positioned proximate to said peel plate and said ring to assist in the transfer of said label from said web to said ring.

8. The label applicator assembly in accordance with claim 5 wherein said ring is formed with a plurality of upstanding pins on its circumferential edges and said web is formed with perforations on its longitudinal edges cooperative with said upstanding pins for guidance and transport of said web.

9. A method of transfer of discrete pressure sensitive labels from a continuous web of discrete pressure sensitive labels to a continuous series of discrete objects to be labeled, the method comprising:
a. contacting a continuous web of discrete pressure sensitive labels tangentially with a perforated rotating label transfer means mounted on a hub, said contact being for a portion of the rotation of said rotating transfer means;
b. transferring said label to said perforated rotating label transfer means by subjecting said label to vacuum means while simultaneously redirecting web away from said rotating transfer means, said vacuum means drawn through said hub;
c. maintaining said label in label side contact with said rotating transfer means for a portion of its arc of circumference by said vacuum means;
d. rotating said label into registration with a pressure port formed in said hub and in communication with a source of pressurized gas;
e. jetting said label from said perforated rotating transfer means to an object to be labeled, said object in registration and alignment with said pressure port;
f. repeat steps a-e.

10. The method in accordance with claim 9 wherein the labels on said web are transferred to said ring with the adhesive side facing outwardly.

11. The method in accordance with claim 9 wherein a pressurized gas assist jet is positioned proximate the said peel plate and said ring to assist in the transfer of said label from said web to said ring.

12. The method in accordance with claim 9 wherein said plurality of directional and tensioning rollers and said ring on said transfer means are formed with pins on their circumferential periphery proximate their ends and said web is formed with perforations on its longitudinal edges cooperative with said pins for the guidance and transport of said web.
